(19) United States
(12) Patent Application Publication
(10) Pub. No.: US 2007/0058356 A1
(43) Pub. Date: Mar. 15, 2007

(54) Meter instrument structure able of changing color

(76) Inventor: Ming-Tsung Chou, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/224,946

(22) Filed: Sep. 14, 2005

(51) Int. Cl. G01D 11/28

(52) U.S. Cl. 362/29

(57) ABSTRACT

A meter instrument structure able of changing color comprising from top to bottom sequentially: a display panel, a light guiding plate, a control circuit having a plurality of light emitting members and a switch, the light emitting members contain light sources at least able to emit two kinds of colors to irradiate the light guiding plate, after the light guiding plate conducts light beams to the entire light guiding plate, the light beams irradiate the display panel to make it shine; The switch controls light emitting members to emit light sources with specific colors, in order to do color changing of the light sources. The structure can be applied to instruments such as voltmeters, water temperature gauges, rotating speed meters, oil meters, speed meters etc.

### BACKGROUND OF THE INVENTION

1. Field of the invention

The present invention relates to a meter instrument structure, and particularly to a meter instrument structure able of changing color, the structure suits instruments such as engine-oil pressure gauges, engine-oil temperature gauges, voltmeters, turbo pressurizers, water temperature gauges, rotating speed meters, oil meters, exhausting thermometers, speed meters etc.

2. Description of the Prior Art

In many cases, meter instruments are widely used as tools for metering, and normally, the instruments that users are most familiar with are those in cars.

In the past, conventional car instruments T10 (as shown in FIG. 3 which is a schematic view showing a rotating speed meter of a car) include each a display panel T12 that is divided into several areas T13. The display panel T12 is pivotally connected with an indicating needle T11; a driver reads an area T13 that the indicating needle T11 points at, and he can be aware of the rotating speed of the engine of the car. The display panel T12 is provided therebeneath with a light guiding plate T14 and a control circuit board T15; the control circuit board T15 is provided thereon with a light emitting member T16. The light emitting member T16 generally is a light emitting diode (LED), it only can emit a light source of a single color; after the light source irradiates the light guiding plate T14, the light guiding plate T14 uniformly conducts light beams it receives to the entire light guiding plate T14, and then irradiates the display panel T12 with the light beams.

An instrument T10 as stated above only is installed with a light emitting diode (LED), so that the light beams shown on the display panel T12 is only monochromic, thereby, a user is unable to change color on the panel of the display panel T12 in complying with his personal fondness, and the light source from the light emitting diode (LED) on a conventional instrument T10 can only be suitable for night illumination rather than daylight illumination.

Therefore, the present invention provides an instrument structure able of changing color, it can solve the problem of inadequacy of conventional techniques, and renders a person to change the color presented on a car instrument in complying with his personal fondness.

### SUMMARY OF THE INVENTION

The primary objective of the present invention is to provide an instrument structure able of changing color in complying with a user's personal fondness.

The secondary objective of the present invention is to provide an instrument structure able of changing color, the structure is provided with a plurality of light emitting members able to give light sources at least with two kinds of colors to meet the requirements of illumination in different times.

To achieve the above objectives of the present invention, the instrument structure able of changing color provided by the present invention comprises sequentially a display panel, a light guiding plate, a control circuit board and a switch; wherein the control circuit includes a plurality of light emitting members to supply light sources at least with two kinds of colors, by light emitting or no light emitting in switching the light emitting members to supply different colors under control of the switch, the light sources irradiate the light guiding plate and irradiate the display panel with light beams, then the display panel gives light beams that the user is fond of.

The present invention will be apparent in its content and the effect to be achieved after reading the detailed description of the preferred embodiment thereof in reference to the accompanying drawings.

### BRIEF DESCRIPTION OF THE DRAWINGS

FIG. 1 is an exploded perspective view showing the elements of an embodiment of the present invention;

FIG. 2 is a perspective view after assembling of the embodiment of the present invention; and

FIG. 3 is an exploded perspective view showing the elements of a conventional meter instrument.

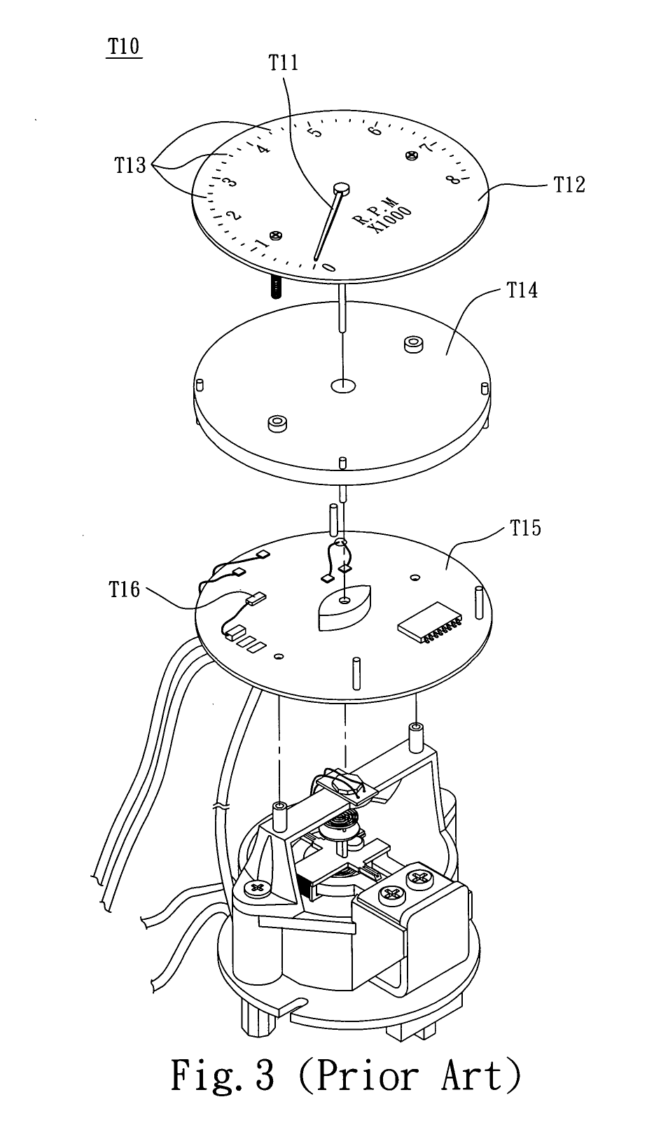

### DETAILED DESCRIPTION OF THE PREFERRED EMBODIMENT

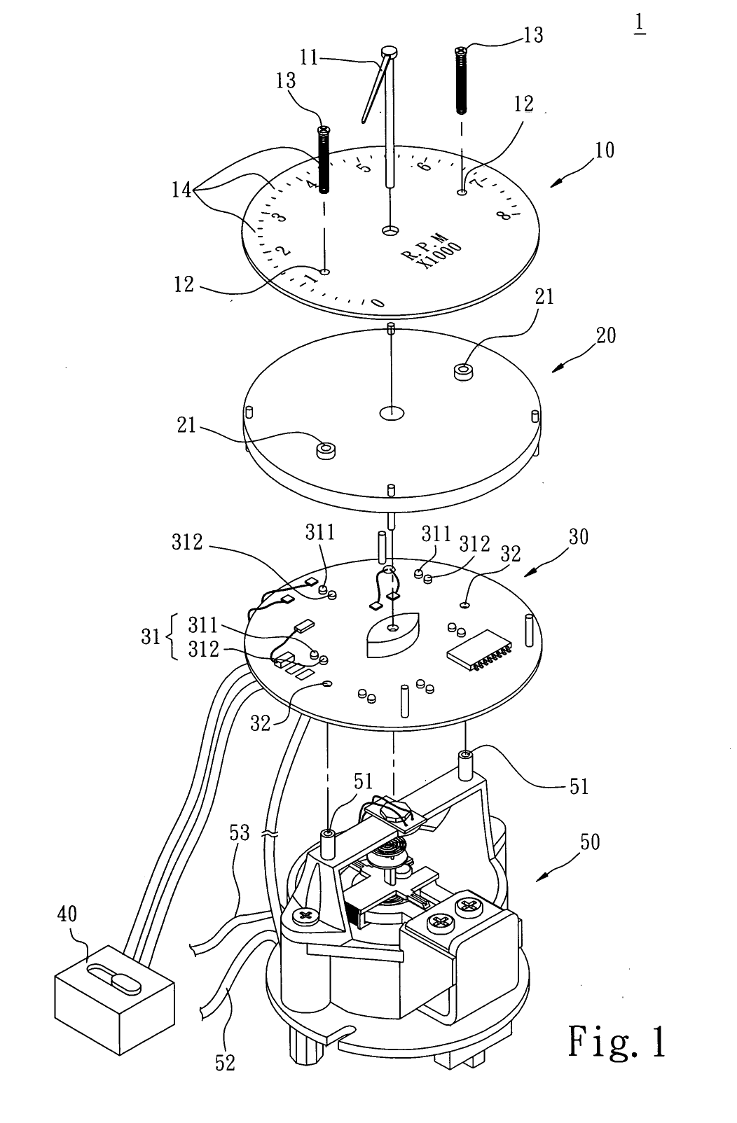

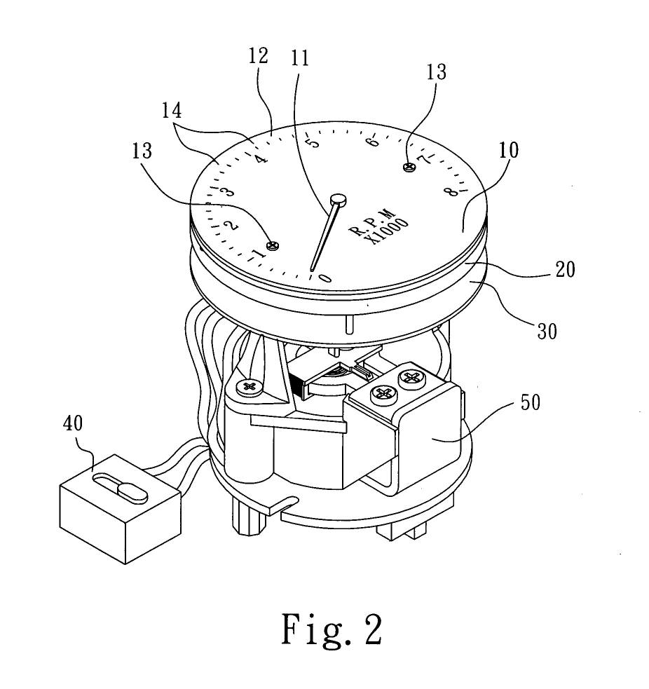

Referring to FIGS. 1 and 2 which are perspective views showing the exploded and assembled states of an embodiment of an instrument structure 1 able of changing color of the present invention, assuming the embodiment is used in a car as an example, from top to bottom, the present invention comprises sequentially a display panel 10, a light guiding plate 20, a control circuit 30 having a plurality of light emitting members 31, a switch 40 and an engine 50.

The display panel 10 generally is round, and is made of transparent material; it is divided into four areas 14 indicating pressure, speed or temperature etc. The display panel 10 is pivotally connected with an indicating needle 11, a user can read desired information shown in an area 14 pointed by the indicating needle 11. The display panel 10 further is provided with a plurality of screw holes 12 to allow a plurality of screws 13 to screw connect the display panel 10, the light guiding plate 20 and the control circuit 30 to the engine 50.

The light guiding plate 20 is provided beneath the display panel 10, after obtaining light sources, it conducts the light beams to the entire light guiding plate 20. The light guiding plate 20 further has a plurality of holes 21 to allow the screws 13 to extend therethrough.

The control circuit 30 is provided beneath the light guiding plate 20, and is provided thereon with a plurality of holes 32 to allow the screws 13 to extend therethrough, so that it can be firmly fixed on fixing holes 51 of the engine 50. The control circuit 30 further is provided with a driving circuit and a plurality of light emitting members 31. The driving circuit is electrically connected with the engine 50 for driving the indicating needle 11. The plural light emitting members 31 preferably are light emitting diodes (LEDs), and the light emitting members 31 can emit light sources at least with two kinds of colors; in this embodiment, for example, they can be LED311 emitting white light sources and LED312 emitting amber color light sources; wherein the LED311 emitting white light sources and the LED312 emitting amber color light sources are provided to be mutually neighboring and to surround and under the light guiding plate 20 to be irradiated; so that the light sources emitted from the plural light emitting members 31 can irradiate upwards the circular peripheral edge of the light guiding plate 20 uniformly. The light guiding plate 20 conducts light beams it receives to the entire light guiding plate 20, and then irradiates the display panel 10 with the light beams, thus the display panel 10 outputs the light beams.

The switch 40 is electrically connected with the control circuit 30 to control whether the LED311 emitting white light sources and the LED312 emitting amber color light sources in the plural light emitting members 31 shine or not, in order to do color changing of the light sources.

When the present invention is applied to a car, and power lines 52, 53 of the engine 50 are connected to the positive as well as the negative electrodes of the switch 40, and electric power is obtained. A user can thus do color changing of the light sources of the plural light emitting members 31 by using the switch 40.

In some other embodiment, plural light emitting members contained in a control circuit similarly can generate at least two kinds of colors of light sources with the switch 40 omitted. For example, one of the colors of light sources is white, while the other of the colors of light sources is amber. In practicing, the light sources with the first and the second colors can be connected in advance to different electric driving power sources to make them give out light. For example, the light source with the first color can be connected to headlights of the car, while the light source with the second color can be connected to small lights of the car, or vice versa. Thereby, the user can decide in advance the colors of the light sources to be emitted from the meter instrument in daytime and night.

Accordingly, the present invention has the following advantages:
1. The meter instrument structure able of changing color of the present invention is provided thereon with a plurality of light emitting members able to give light sources at least with two kinds of colors, and with a switch to make light emitting or not emitting of the light emitting members, so that a user can decide the color emitted from the instrument in complying with his personal fondness.
2. The light emitting members of the instrument can have other light emitting diodes (LEDs) for giving out other colors, so that light sources with the colors suiting the user no mater in daylight or at night can be provided.
3. The light sources given by the instrument of the present invention can be connected to different electric driving power sources to make them give out light. Hence for manufacturers, cost of manufacturing switches can be saved.

In conclusion, according to the description disclosed above, the present invention surely can get the expected object thereof to provide a meter instrument structure able of changing color. By disclosing of this specification, it will be apparent to those skilled in this art that the present invention is practicable. While the embodiment given is only for illustrating the present invention, and not for giving any limitation to the scope of the present invention; it will be apparent to those skilled in this art that various equivalent modifications or changes without departing from the spirit of this invention shall also fall within the scope of the appended claims.

1. A meter instrument structure able of changing color comprising:
a display panel;
a light guiding plate provided beneath said display panel;
a control circuit board provided beneath said light guiding plate, and provided with a plurality of light emitting members, said light emitting members are adapted to emitting light sources at least with two kinds of colors and irradiating said light guiding plate, said light guiding plate conducts light beams it receives to the entire of said light guiding plate, and then makes said display panel give out light; and
a switch electrically connected with said control circuit to control said light emitting members to emit light sources with specific colors, in order to do color changing of said light sources.

2. The meter instrument structure able of changing color as stated in claim 1, wherein said plural light emitting members include light emitting members emitting white light sources and light emitting members emitting amber color light sources.

3. The meter instrument structure able of changing color as stated in claim 1, wherein said display panel is made of transparent material, and is divided into a plurality of indicating areas, and is pivotally connected thereon with an indicating needle for indicating position.

4. The meter instrument structure able of changing color as stated in claim 3, wherein said control circuit further is provided with a driving circuit for driving said indicating needle.

5. The meter instrument structure able of changing color as stated in claim 1, wherein said light emitting members are light emitting diodes (LEDs).

6. A meter instrument structure able of changing color comprising:
a display panel;
a light guiding plate provided beneath said display panel;
a control circuit board provided beneath said light guiding plate; said
meter instrument structure is characterized in that:
said control circuit is provided with a plurality of light emitting members, said light emitting members are adapted to emitting light sources at least with two kinds of colors, said light sources with a first color and a second color are driven respectively by different power sources for light emitting, and said light emitting members irradiate said light guiding plate, said light guiding plate conducts light beams it receives to the entire of said light guiding plate, and then irradiates said display panel to make said display panel give out light.
